(19) United States
(12) Patent Application Publication
(10) Pub. No.: US 2008/0215220 A1
(43) Pub. Date: Sep. 4, 2008

(54) Method and Device for Control of an Automated Friction Clutch Between an Engine and a Gearbox

(75) Inventors: Matthias Winkel, Weingarten (DE); Ramon Cordt, Friedrichshafen (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 11/916,849

(22) PCT Filed: Jun. 2, 2006
(86) PCT No.: PCT/EP2006/005256

§ 371 Date: Dec. 7, 2007

(30) Foreign Application Priority Data
Jun. 9, 2005 (DE) 102005026615.0

(51) Int. Cl. F16D 48/06; G06F 17/00

(52) U.S. Cl. 701/68

(57) ABSTRACT

A method for controlling and reducing the load on an automated clutch. Based on a variety of parameters, a conclusion based on the load status of the clutch or the friction elements regarding thermal load or wear is obtained. A clutch control module compares the load values, determined in this way, to the associated threshold values. If these threshold values are exceeded, the clutch control module initiates measures for reducing the load on the clutch. The measures do not require action by an operator and are based on action of the clutch controller, the drive motor, and/or the transmission such that the thermal load and/or the wear on the clutch are reduced. A plurality of load values and measures are considered for starting or stopping the vehicle on a gradient via the accelerator and for gear change operations during driving.

This application is a national stage completion of PCT/EP2006/005256 filed Jun. 2, 2006, which claims priority from German Application Serial No. 10 2005 026 615.0 filed Jun. 9, 2005.

### FIELD OF THE INVENTION

The invention relates to a method for controlling an automated friction clutch and to an apparatus for performing this method.

### BACKGROUND OF THE INVENTION

Automated friction clutches, which is to say clutches based on friction which actuation is not controlled directly by an operator, have been used in different motor vehicle types for quite some time. Particularly in vehicles with automatic transmissions, automated friction clutches are actively used regularly during gear changes and starting processes. In addition, they are also used increasingly in vehicles with manual transmissions. In these, the request for a gear is input directly by the driver, generally in the form of an electric or electronic signal, which is processed by a controller and ultimately brings about the activation of actuators, which control the true coupling and shifting process. Even in cases in which a clutch pedal to be actuated by the driver is provided, the control of the clutch position by actuators offers a variety of advantages with respect to the forces to be applied by the driver, the pedal travel, the accuracy of the adjustment of the clutch and, particularly in special vehicle states, of the transmission or clutch proper.

A further advantage of automated friction clutches, with appropriate activation, is less wear per coupling operation so that a longer service life of the friction clutch and/or smaller dimensions of the same for the same service life can be achieved.

The controllers of automated friction clutches are typically configured such that advantageous driving properties of the vehicle are obtained. This includes, for example, that during starting operations, a relatively generous slippage range is provided for the friction clutch, allowing the driver to precisely meter the increase in speed of the vehicle and enabling a comfortable maneuvering operation and even on relatively large gradients, enabling the driver to maintain the vehicle in the standstill position by actuating the accelerator without actuating a brake.

Furthermore, it is common to decrease the time period of the absence of torque during a shifting operation by disengaging the friction clutch prior to reaching a minimum rotational speed differential between the input shaft and output shaft of the friction clutch. Particularly in this situation, generally a higher input rotational speed of the clutch is selected—in accordance with an engine rotational speed that is higher than during operation with a completely disengaged clutch-in order, in conjunction with an appropriate input torque, to be able to transmit torque to the transmission disposed downstream in the drive mechanism already while disengaging the clutch.

The above designs of the clutch controller, however, result in a longer slip period of the clutch and/or in increased work to be performed on the friction elements during slippage of the clutch and in increased stress on the clutch. This increased stress is reflected in increased wear of the friction elements and in an increased temperature of the same.

When neglecting fringe effects, the power acting on the clutch in the slippage operation P_{Kup} can be described by the formula

P_{Kup}=2π(n_{Ein}−n_{Aus})*M_{Mot} Formula (1).

The power P_{Kup} acting on the clutch is accordingly dependent on the amount of the engine torque M_{Mot} and the difference in the rotational speeds between the friction linings of the clutch input shaft n_{Ein}, and the clutch output shaft n_{Aus}.

The energy input in the clutch Q_{Kup} is obtained from the integration of the power acting on the clutch over time:

$${Q}_{Kup} = {\int }_{t = 0}^{t} {P}_{Kup} d t \qquad Formual ( 2 )$$

This energy input Q_{Kup} corresponds to the work performed on the clutch and/or the friction elements of the clutch and results, on the one hand, in wear of the friction elements and, on the other hand, in a temperature increase of the friction elements and consequently on further clutch elements. To estimate the temperature change of the clutch or the friction linings thereof Δθ_{Kup}, it suffices to look at the sum Q_{Kup,ges} from the energy Q_{Kup,zu} supplied to the clutch and the energy Q_{Kup,ab} removed from the clutch. This results in:

Δθ_{Kup}=(Q_{Kup,zu}−Q_{Kup,ab})=Q_{Kup,ges} Formula (3)

Depending on the desired accuracy of the temperature determination, the values for the energy supplied to and removed from the clutch can be determined in different complexities and, if necessary, further influencing factors, such as the outside temperature and/or the temperature of any oil potentially present in the clutch can be taken into consideration. Of course, it is also possible to measure the temperature of the friction linings directly or indirectly by way of temperature sensors, however this is frequently associated with higher costs.

Regardless of the type of the temperature determination, the wear of the friction elements of the clutch considerably increases with rising temperatures, at least above a threshold temperature. As the temperature increases further, there is a risk that the clutch is damaged or even destroyed. For this reason, a variety of apparatuses and methods for protecting a clutch from overheating have been previously proposed.

From DE 33 34 725 A1, an apparatus to protect a clutch from overheating is known, wherein a torque transmitted by the clutch or introduced in a clutch by a drive motor and a difference, between a clutch input speed and a clutch output speed, are determined, the product thereof is calculated and an alarm delay time is assigned to this product with the aid of a table. The respectively current slip time is compared to the alarm delay time and a warning signal is generated if the alarm delay time is exceeded.

In a further development of this apparatus, it is provided that the presently determined slip time is added to the previously determined slip times and the stored slip time is continuously lowered or in stages. In this way, the cumulatively acting heating from consecutive slip times and the cooling of the clutch from dissipation of the heat to the outside are taken into consideration. After the alarm delay time has expired, a warning signal is issued to the driver. A change of the clutch controller is initially not provided for here.

The apparatus described above is thus based on determining a fictitious idle period, which is required, subsequent to a slip phase of the clutch, in order to prevent overheating of the same by a further slip phase, wherein a warning signal is issued to the driver if the alarm delay time is not adhered to.

A driver with average skills will generally not be in a position to expediently translate such a warning signal into a change in behavior. It can be assumed that a warning signal cautions the driver to pursue a more careful driving style. This careful driving style, however when stopping the vehicle on a gradient, can only result in the use of the vehicle brakes to shorten the clutch slip times if the driver is familiar with the physical background information. In addition, the triggering of a warning signal almost automatically results in decreased confidence of the driver in the performance and/or reliability of the vehicle and should therefore be avoided whenever possible from a marketing aspect.

While the object of the invention is to guarantee overheating protection for the clutch in all operational states, DE 33 34 725 A1 at least primarily relates to automatically actuated clutches in which the driver, when stopping the vehicle on a gradient, causes clutch slippage by actuating the accelerator for an extended period. It is only in a special embodiment of this known apparatus that a second alarm delay time may be provided, after the expiration of which an apparatus is actuated for the slow and steady engagement of the clutch.

For operational states other than the described stopping of a vehicle on the gradient by actuating the accelerator, nothing whatsoever is proposed with respect to the automatic influencing of the control of the clutch. This is all the more serious because the intervention possibilities of the driver in these cases are severely limited because the acceleration and speed profile of the vehicle is substantially determined by the traffic situation. With the known method, the only option the driver has is essentially to park the vehicle for a certain time period after the warning signal has been activated in order to allow the clutch to appropriately cool off. If such a step is even possible in the situation described above, an apparatus of this type, in any case, is unsatisfactory.

According to DE 103 12 088 A1, a quantity of energy dissipated in the clutch or the temperature of the clutch is monitored by a control device when the friction clutch is slipping and the output torque of the engine is reduced when limit values are exceeded. This method also has certain disadvantages. The energy quantity dissipated in the clutch depends not only on the torque of the engine, but on the product of the same and the rotational speed differential of the clutch. The proposed method is perceived negatively by the driver in the form of a loss of power of the engine and in addition on steep gradients, may result in a situation in which the reduced engine torque is no longer sufficient for appropriate acceleration, consequently triggering additional shifting processes, which aggravate the problem further.

Against this background, it is the object of the invention to provide a control method and a controller for an automated friction clutch with which, in a normal driving mode, control of the friction clutch that corresponds to the conventional clutch control and that is optimized with respect to the driving behavior is possible. In the presence of certain conditions, however, the control of the friction clutch and optionally of the motor and the transmission can be modified by a clutch control module such that damage to the clutch is prevented and/or wear of the friction surfaces is reduced.

Hereinafter, unless expressly stated otherwise, a clutch shall be understood as an automated friction clutch, as it is provided in many cases between the drive motor and the automatic transmission of a vehicle. The most significant applications are passenger cars or commercial vehicles with internal combustion engines and transmissions comprising a plurality of separately shiftable gear ratios. Likewise, the invention can be advantageously used in other types of drive motors, transmissions or vehicles, such as watercraft or motorcycles.

### SUMMARY OF THE INVENTION

The invention is based on the knowledge that a variety of parameters allow a conclusion on the load state of the clutch or of the friction elements thereof with respect to the thermal load and/or wear and that a clutch control module can take measures by which a reduction of stress in the clutch is achieved with the help of these values and a comparison to associated threshold values. The invention is further based on the realization that information for the driver about the load state of the clutch in the form of a warning signal is not desirable, while an automatic and direct autonomous initiation of relieving measures is more effective. Finally, the inventors realized that a monitoring of a plurality of parameters and threshold values enables a particularly accurate estimation of the actual load state of the clutch and that the load on the clutch can be particularly effectively reduced by triggering a plurality of different measures.

Accordingly, the invention is based on a method for controlling an automated clutch for reducing the stress of the same where, on an input side of the clutch, torque of a drive motor is applied and a transmission is disposed downstream of this clutch in the drive mechanism, the transmission having different gear ratios. In addition, a clutch control module is provided, which can act on the operation of the clutch, the drive motor and/or of the transmission.

The clutch, the drive motor and the transmission generally comprise controllers, which may be linked among each other or can be partially or completely integrated. It is insignificant whether the clutch control module directly influences a clutch, a transmission and/or a drive motor or does so by way of an appropriate controller. Also with respect to control devices or control modules, the term control shall always be understood as a generic term which, in addition to mere controls, also comprises regulating devices.

To achieve the objective in question, it is provided with respect to the method that the clutch control module reads in data, with the help of which at least one load value of the clutch regarding a thermal load and/or wear of the clutch, is determined. These data can be physical variables detected by sensors or values obtained with the help of tables and/or mathematical operations based on the available data.

The clutch control module compares the load value or values ascertained to the threshold values and, if at least one threshold value is exceeded, initiates measures which, without action by an operator or driver influence, a controller of the clutch and/or of the drive motor and/or of the transmission such that the thermal load on the clutch and/or the wear thereof are reduced. As a result, the quality of the method increases with the number of parameters monitored or employed and with the number of possible measures that can be triggered.

If at least one threshold value is exceeded, the clutch control module preferably initiates measures without previously informing an operator or driver by way of a relevant signal since, as described above, the benefit of such information is doubtful for an average driver and, in addition, may contribute to unsettling or reducing the confidence of the driver in the abilities and reliability of his vehicle. In addition, the initiated measures can be performed effectively sooner in the absence of any delay caused by the prior issue of a warning message and can therefore be performed more gently, while achieving the same protective effect.

Hereinafter, first a few particularly advantageous parameters for forming a load value of a clutch will be described. Then, particular advantageous measures will be outlined, where first measures will be addressed which are particularly advantageous during starting operations, followed by measures which are particularly useful during shifting operations. Of course, it is also possible in individual cases to expediently employ certain measures that are outlined in conjunction with starting operations for shifting operations and, vice versa, so that the association below shall not be understood as a limitation.

A first refinement, regarding the formation of a load value, provides that the clutch control module monitors the overall heat amount introduced into the clutch, compares it to a first threshold value and initiates measures if the first threshold value is exceeded, through which the thermal load on the clutch and/or the wear thereof are diminished.

The determination of the overall heat amount can be made, for example, according to Formula (3) above, however, other suitable calculations or estimations are also possible. Measuring the temperatures of the relevant parts can therefore be dispensed with. Measuring particularly the temperature of the friction surfaces of a clutch is frequently associated with considerable expenses, which can be prevented in this way by relatively simple calculations on the basis of data that is available anyhow.

A second configuration of the invention is characterized by a clutch control module monitoring the temperature of the clutch and/or of friction elements of a clutch, comparing it to a second relevant threshold value and initiating measures, if the second threshold value is exceeded, where the measures reduce the thermal load on the clutch and/or the wear thereof. The temperature of the clutch and/or of the friction elements is preferably measured directly. This can also be done in a contactless manner. Insofar as appropriate, sensors are already available on the transmission in question or, if equipping it, accordingly is possible with little added expense, particularly current and reliable values can be obtained.

Alternatively or additionally, the clutch control module can monitor the slip duration of the clutch, compare it to a third relevant threshold value and initiate measures if the third threshold value is exceeded, wherein the measures reduce the thermal load on the clutch and/or the wear thereof.

The slip duration can be determined with minimal expense and already allows certain conclusions of the load situation of the clutch. Nevertheless, the slip duration is preferably used as a single value only if the method must be implemented in a particularly simple and cost-efficient manner. Otherwise, it is included in the method as an additional load value.

A qualitatively different load value can be obtained by monitoring the wear of the clutch or friction linings. If the clutch control module monitors the friction lining or linings with respect to meeting a fourth threshold value regarding wear and if it initiates measures if this fourth threshold value is exceeded, wherein the measures reduce the thermal load on the clutch and/or the wear thereof, the remaining service life of the clutch can be considerably extended, so that a replacement of the friction linings can be postponed to the end of a road trip or the next planned inspection.

This load value is particularly suited to trigger measures, regardless of the above-described load values, and to modify the threshold values for the remaining load values and thus allow the method to respond with greater sensitivity as the wear of the friction linings increases.

In principle, it is up to the developer in each case whether to determine only one, a plurality or all of the aforementioned load values and in what way mathematical operations or Boolean operations of these load values and/or the associated threshold values may be provided for.

It is expedient, however, if the clutch control module initiates one to four measures if at least one of the above threshold values is exceeded, wherein the measures reduce the thermal load on the clutch and/or the wear thereof during starting operations, because frequently the clutch is subject to considerable stress, particularly during starting operations. This is particularly true for the problem, described at the beginning, of a clutch controller that is aimed at optimized driving performance and with respect to the also previously mentioned problem of a vehicle that is maintained on a gradient with the help of the accelerator.

According to a first advantageous measure, the clutch control module brings about an automatic engagement of the clutch if at least one of the above mentioned threshold values one to four is exceeded. This closure is preferably performed at a relatively slow speed so that the driver is given sufficient opportunity to prevent the vehicle from rolling or further accelerating by actuating the brake.

Furthermore, it Is expedient if the clutch is not disengaged permanently, but is re-engaged after a predefined time period. In this way, it is considerably more difficult for the driver to keep the vehicle in a standstill position by varying the position of the accelerator. If necessary, the clutch controller or the clutch control module can, of course, interact with further systems, such as a collision warning device, in order to prevent impact with an obstacle in the case of a delayed or insufficient response by the driver.

If the clutch control module according to a further step of the method of the invention, brings about an acceleration of the engaging process of the clutch upon exceeding at least one of the above threshold values one to four, the slip time of the clutch during a starting operation is considerably reduced and the load on the clutch is thereby lowered.

Finally, it may be provided that the clutch control module brings about a repeated, brief and increasing and decreasing acceleration of the vehicle and/or a vibration of the vehicle by influencing the clutch controller if at least one of the above threshold values one to four is exceeded. This does not constitute an engagement of the clutch with subsequent disengaging of the clutch described above in the event of an insufficient response by the driver, but an activation of the clutch and/or transmission resulting in an oscillation or a vibration of the vehicle along the longitudinal axis thereof, which occurs when a clutch grabs. These vibrations prompt the driver to end this unpleasant state by actuating the brake or starting to drive.

The advantageous difference, compared to a mere warning signal mentioned at the beginning in the form of a warning lamp or an audio warning is that with a vibrating vehicle the desired response is directly obvious, even to drivers with average skills without the physical background knowledge, and that the motivation for the driver to exhibit the desired gentle behavior on the clutch is considerably greater than in the case of a warning lamp. In addition, depending on the controller of the clutch and the engine, the total load on the clutch can be kept lower than in a constant state of the clutch.

While above possible measures for a standing vehicle or for a starting operation were explained, hereinafter measures will be described which are expedient particularly during gear change processes. A gear change process shall be understood as the change from one gear to another gear while driving.

If the clutch control module initiates measures if at least one of the above threshold values one to four is exceeded, wherein the measures reduce the thermal load on the clutch and/or the wear thereof during gear change processes, in this way further damage can be prevented, particularly in the case of preceding starting operations having a long slip time or resulting in considerable heating of the friction linings.

In addition, however, also further situations arise in which the clutch experiences high stresses from gear changes while driving. Among other things, this includes mountain drives with frequent gear changes caused by curves and different gradients and trips with frequent and strong acceleration.

If the clutch control module, after at least one of the above threshold values one to four is exceeded, determines whether the rotational speed differential between the current rotational speed of the clutch and the rotational speed of the clutch in the target gear is below a relevant fifth threshold value and, in this case, if the transmission controller, the clutch controller and/or the engine controller is influenced such that the shifting operation is performed without disengaging the clutch, then slippage of the clutch can be completely prevented at least in some of the total number of gear changes. The lower the rotational speed differential, the easier it is to forego a separation of the power train by the clutch. This is possible particularly with gears having very close ratios.

If the clutch control module can influence the engine controller, an appropriate activation of the engine, after taking out the existing gear, can result in an adjustment to a suitable engine rotational speed in the neutral position of the transmission and a gear change can be performed, likewise without the involvement of the clutch.

According to a further development of the method, the clutch control module, after at least one of the first to fourth threshold values is exceeded, can influence the transmission controller, the clutch controller and/or the engine controller such that the rotational speed differential at the clutch is below a sixth relevant threshold value when engaging the clutch. In this case, the clutch is also disengaged for the gear change and then engaged again, which has a positive overall impact on the shifting comfort and wear of the transmission. By largely adjusting the engine rotational speed and hence the rotational speed of the clutch input side to the rotational speed of the clutch output side, still only very little or even no appreciable slippage of the friction linings occurs. The acceleration behavior of the vehicle becomes slightly worse, because the time period for the load loss is slightly longer for a precise adjustment of the engine rotational speed.

The lower the rotational speed differential at the clutch upon disengaging, the lower is the stress of the clutch and the greater are the losses with respect to the acceleration behavior of the vehicle. To use the clutch as gently as possible, it is therefore advantageous to keep the sixth threshold value to a minimum.

A similar development of the method provides for the clutch control module, after at least one of the first to fourth threshold values is exceeded, to influence the transmission controller, the clutch controller and/or the engine controller such that noticeable torque transmission from the drive motor to the transmission does not take place until the clutch is nearly completely engaged. In this way, at a given initial rotational speed differential at the clutch, the work performed on the clutch is reduced resulting in lower stress of the clutch.

Another approach is based on reducing the overall number of shifting operations instead of making the individual shifting operations as gentle for the clutch as possible. If the clutch control module, after at least one of the first to fourth threshold values is exceeded, influences the transmission controller, the clutch controller and/or the engine controller such that the average number of shifting processes per time interval decreases compared to a normal operation, the load acting on the clutch per time interval or covered distance also decreases. In addition, the load-free phases become longer, giving the clutch more opportunity to dissipate the energy absorbed in the form of heat to the environment.

This can occur particularly easily in that the clutch control module, after at least one of the first to fourth threshold values is exceeded, influences the transmission controller, the clutch controller and/or the engine controller such that the gear-related lower rotational speed limits are lowered and/or the gear-related upper rotational speed limits are increased and/or the range of permitted engine rotational speeds is increased.

So far, the individual load values and measures were described substantially separately from one another in order to provide a clear and understandable illustration. In practice, however, it is expedient if the clutch control module determines two or more load values of the clutch regarding a thermal load and/or wear of the clutch and links them to form a higher-level load value and if the clutch control module then compares the determined higher-level load value or values to one or more relevant threshold values, and if at least one threshold value is exceeded, initiates measures which act on the controller of the clutch, the drive motor and/or the transmission, without the involvement of an operator or driver, such that the thermal load on the clutch and/or the wear thereof are reduced. If a plurality of threshold values are exceeded, increasingly preferably a plurality of the above measures are initiated.

In this way, it is also possible to alternatively or cumulatively apply a plurality of measures already if one threshold value is exceeded, particularly however if a plurality of threshold values are exceeded or if a threshold value for a higher-level load value is exceeded. It is expedient if a threshold value is exceeded during a starting process, to increase the engagement speed of the clutch and during the subsequent shifting processes to reduce the shifting frequency by increasing the speed ranges of the individual gears, and possibly by skipping individual gears and, at the same timer during the shifting processes, only engage the clutch if the rotational speed differential has dropped below a low threshold value.

While above the method of the invention was described in detail, hereinafter an apparatus for conducting the method will be described in more detail. To begin with, it shall be mentioned that it is, of course, common in practice and frequently advantageous to combine certain control modules or control units with other relevant modules or units, also to separate them or to design the communication paths between the units and modules differently.

The apparatus is based on an automated clutch comprising an input side and an output side. Connected to the clutch are a drive motor, the output shaft of which is connected in a rotationally fixed manner to the input side of the automated clutch and a transmission, the input shaft of which is connected in a rotationally fixed manner to the output side of the automated clutch. An engine control device for controlling the drive motor, a transmission control device for controlling the transmission and a clutch control device for controlling the automated clutch are, likewise, provided and can be connected to one another, preferably via a data bus, which is a vehicle-internal data transmission system.

In addition, the apparatus is characterized such that a clutch control module is provided, which is configured so that it can read in data of at least the clutch control device. It is further configured such that it is able to process the data into a load value of the automated clutch regarding the thermal load and/or wear.

A device for storing and/or determining threshold values for the load value or values is provided, wherein the device may form an integral part of the clutch control module or also a separate electric or electronic module or it can be integrated in a further module.

Furthermore, the clutch control module comprises a device for comparing the determined load values to these threshold values. Finally, an output apparatus is provided as part of the clutch control module. If one or more threshold values are exceeded, the apparatus is able to act on the automated clutch, the transmission and/or the engine or the associated control devices such that the thermal load on the clutch and/or the wear thereof are reduced.

### BRIEF DESCRIPTION OF THE DRAWING

The invention will now be described, by way of example, with reference to the accompanying drawing in which:

FIG. 1 is a diagrammatic illustration showing a power train of a vehicle.

### DETAILED DESCRIPTION OF THE INVENTION

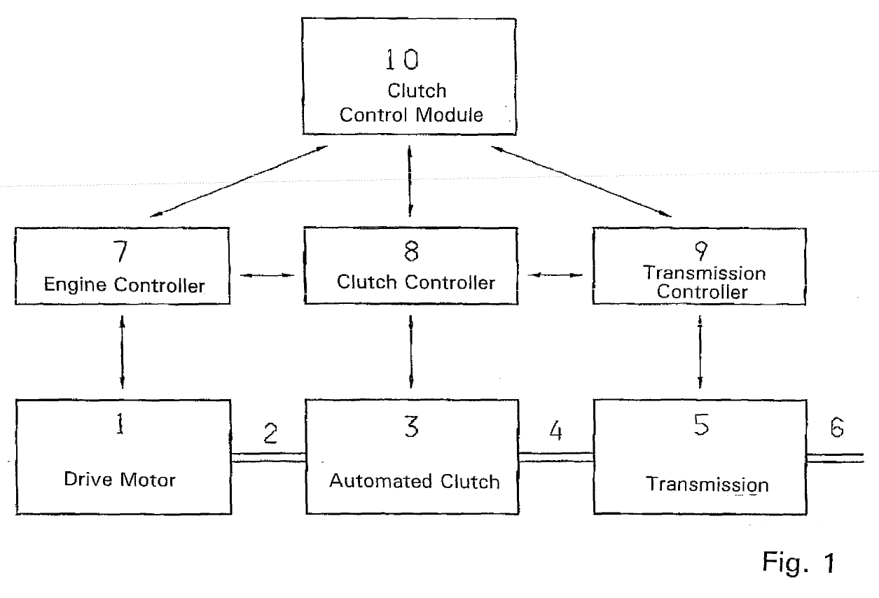

FIG. 1 shows the power train of a vehicle comprising a drive motor 11 an automated clutch 3 and a transmission 5, where an output shaft of the drive motor 1 is connected via a first rotationally fixed connection 2 to the input side of the automated clutch 3, while the output side of this clutch 3 is drivably connected via a second rotationally fixed connection 4 to the input shaft of the transmission 5. The output shaft of the transmission 5 is connected via a third rotationally fixed connection 6 to a differential gear (not shown), and finally to the driven wheels of a motor vehicle.

The drive motor 1 is associated with an engine controller 7, the automated clutch 3 with a clutch controller 8 and the transmission 5 with a transmission controller 9, wherein these controllers 7, 8, 9, as indicated by the double arrows, can bi-directionally exchange information not only with the associated units 1, 3, 5, but are also connected among one another via a data bus. Furthermore, they are connected to a clutch control module 10.

The clutch control module 10 reads data from the clutch controller 8 regarding the duration of the last slip phase of the clutch 3 and the input rotational speed and output rotational speed thereof. If the clutch 3 is provided with dedicated temperature sensors, these values are first sent to the clutch controller 8 and are then forwarded to the clutch control module 10.

The rotational speed values of the input and output sides of the clutch 3 can also be read by the engine controller 7 and the transmission controller 9. In addition, the engine controller provides data about the torque currently present at the output shaft of the drive motor 1.

The clutch control module 10 uses these and optional further values to determine one or more load values of the clutch 3. In a memory which, in this case, is integrated in the clutch control module 10 and is not shown separately, threshold values are stored for the individual load values. If a comparison unit, which is likewise integrated in the clutch control module 10 and is not shown separately, determines that the load values exceed one or even a plurality of threshold values, the clutch control module 10 initiates measures for reducing the clutch load in that it emits appropriate signals to the clutch controller 8, the engine controller 7 and/or to the transmission controller 9. The individual measures have already been described above, in detail. The type of the signals depends on the control devices 7, 8, 9 and data protocols used.

### REFERENCE NUMERALS

1 drive motor
2 first torsion-resistant connection
3 automated clutch
4 second torsion-resistant connection
5 transmission
6 third torsion-resistant connection
7 engine controller
8 clutch controller
9 transmission controller
10 clutch control module
M_{Mot} engine torque
n_{Aus} clutch output shaft
n_{Ein} clutch input shaft
P_{Kup} slippage operation
Qₖᵤₚ energy input in the clutch

1-19. (canceled)

20. A method of controlling an automated clutch (3) for reducing a load on the clutch (3) in a drive mechanism with torque from a drive motor (1) being applied on an input side of the clutch (3) and a transmission (5) being arranged downstream of the clutch (3), the transmission having different gear ratios, and a clutch control module (10) being provided which acts on an operation of one or more of the clutch (3), the drive motor (1) and the transmission (5), the clutch control module (10) reading data with which the clutch control module (10) determines at least one load value of the clutch (3) regarding at least one of a thermal load and a wear of the clutch (3), and comparing at least one of the determined load values to threshold values via the clutch control module (10), initiating measures if at least one threshold values is exceeded, acting on a controller of at least one of the clutch (8), the drive motor (7) and the transmission (9), without action by an operator, such that at least one of the thermal load and the wear of the clutch (3) are reduced, the clutch control module (10), if at least one of the threshold values is exceeded, initiates measures which reduce at least one of the thermal load and the wear of the clutch (3) during a gear shifting operation, and determining whether a rotational speed differential between a current output rotational speed of the clutch (3) and a desired rotational speed of the clutch (3), for a target gear, is below a further threshold value, and if so influences at least one of the transmission controller (9), the clutch control unit (9) and the engine control unit (7) such that the gear shifting operation is performed without disengaging the clutch (3).

21. The method according to claim 20, further comprising the step of, if at least a first threshold value is exceeded, influencing at least one of the transmission controller (9), the clutch controller (8) and the engine controller (7), with the clutch control module (10), such that at least one of gear-related lower rotational speed limits are lowered, gear-related upper rotational speed limits are increased and a range of permitted engine rotational speeds is increased.

22. The method according to claim 20, further comprising the step of determining, with the clutch control module (10), at least two load values of the clutch (3) regarding at least one of the thermal load and the wear of the clutch (3) and combining the at least two load values into a higher-lever load value such that the clutch control module (10) compares a determined higher-level load value to at least one threshold value, and if at least one threshold value is exceeded, initiating measures which influence the controller of at least one of the clutch (8), the drive motor (7) and the transmission (9), without action by the operator, such that at least one of the thermal load on the clutch (3) and the wear on the clutch are reduced, and increasingly initiates a plurality of the measures if a plurality of threshold values are exceeded.

23. A method for reducing load on an automated clutch (3) in a vehicle having a drive motor (1) applying torque to an input side of the clutch (3) and the clutch (3) transmitting the torque, via an output side of the clutch (3), to a transmission (5) having different gear ratios, the clutch (3) having a clutch control module (10) which influences operation of at least one of the clutch (3), the drive motor and the transmission (5), the method comprising the steps of:
monitoring data with the clutch control module (10);
determining, with the clutch control module (10) using the data, at least one load value of the clutch (3) with regard to at least one of a clutch thermal load and a clutch wear;
comparing, with the clutch control module (10), at least one of the load values to at least one threshold value;
influencing, with the clutch control module (10), at least one of a drive motor controller (7), a clutch controller (8), and a transmission controller (9), to initiate at least one measure for reducing at least one of the clutch thermal load and the clutch wear, if at least one of the load values exceeds at least one of the threshold values;
determining, with the clutch control module (10), a rotational speed differential between a current rotational speed of the output side of the clutch (3) and a rotational speed of the output side of the clutch (3) in a desired gear ratio, if the at least one measure, for reducing at least one of the clutch thermal load and the clutch wear, is initiated during a shift between different gear ratios;
comparing, with the clutch control module (10), the rotational speed differential with a further threshold value; and
influencing, with the clutch control module (10), at least one of the drive motor controller (7), the clutch controller (8), and the transmission controller (9), to shift between the different gear ratios without disengaging the clutch (3), if the rotational speed differential is lower than the further threshold value.

24. The method for reducing load on an automated clutch (3) according to claim 23, further comprising the steps of defining the load values as:
an overall heat amount introduced into the clutch (3);
a temperature of at least one of the clutch (3) and friction elements of the clutch (3);
a duration of clutch slip; and
an amount of wear of at least one of the clutch (3) and the friction elements of the clutch (3).

25. The method for reducing load on an automated clutch (3) according to claim 24, further comprising the steps of defining the measures for reducing at least one of the clutch thermal load and the clutch wear as:
automatically engaging the clutch (3);
re-engaging the clutch (3) after a predefined time period, if the clutch (3) is not disengaged permanently;
accelerating engagement of the clutch (3);
repeatedly and briefly increasing and decreasing at least one of acceleration of the vehicle and vibration of the vehicle by influencing the clutch controller;
withholding noticeable transmission of torque from the drive motor (7) to the transmission (9) until the clutch (3) is nearly completely engaged;
reducing an average number of shifts between the different gear ratios per time interval compared to a normal average number of shifts between the different gear ratios per time interval; and
at least one of reducing gear-related lower rotational speed limits, increasing gear-related upper rotational speed limits and increasing a range between permitted gear-related lower rotational speed limits and permitted gear-related upper rotational speed limits.
